(19) United States
(12) Patent Application Publication
(10) Pub. No.: US 2003/0220078 A1
(43) Pub. Date: Nov. 27, 2003

(54) Circuit for testing functions of a radio-frequency circuit

(76) Inventor: Dirk Matuszczak, Alpen (DE)

Correspondence Address: Bell, Boyd & Lloyd LLC, P.O. Box 1135, Chicago, IL, 60690, US

(21) Appl. No.: 10/378,170

(22) Filed: Mar. 3, 2003

(30) Foreign Application Priority Data
Mar. 1, 2002 (EP) 02004777.5

(51) Int. Cl. H04B 17/00

(52) U.S. Cl. 455/67.11

(57) ABSTRACT

A circuit is provided for testing functions of a radio-frequency circuit wherein, as opposed to known prior art circuit s which have a test point for a test element, at which a signal to be tested is tapped off from the radio-frequency circuit, and a short-circuiting point for a short-circuiting element, via which an additional circuit component, which is connected to the radio-frequency circuit via a lambda/4 piece of line, is short-circuited, the inventive circuit includes a test point which physically coincides with the short-circuiting point, with the resultant test/short circuiting point having a signal contact for the signal to be tested and a ground contact, which are connected via the lambda/4 piece of line, and with the additional circuit component being connected to the ground contact.

### BACKGROUND OF THE INVENTION

The present invention relates to a circuit for testing functions of a radio-frequency circuit, having a test point for a test element, at which a signal to be tested is tapped off from the radio-frequency circuit, and having a short-circuiting point for a short-circuiting element, via which an additional circuit component, which is connected to the radio-frequency circuit via a lambda 4 piece of line, is short-circuited.

A circuit such as this is used, for example, in mobile telephones in order to separate a circuit component, such as an integrated antenna, via a lambda 4 piece of line, in which case a radio-frequency circuit has to be tested for inspection purposes at a test point during production.

The radio-frequency circuit is tested using a test needle during the process of testing the mobile telephone for inspection purposes during production. Radio-frequency measurements such as these relate to a characteristic impedance Z0 which, in most cases, is 50 Ohms. If the impedance differs from this, then the measurement results obtained using the test needle at the test point have been corrupted, and satisfactory testing of the radio-frequency circuit is impossible.

Incorrect measurement results occur, for example, if the test needle makes contact with the selected test point, and the rest of the circuit, which is already designed for normal operation of the mobile telephone on the impedance Z0, is influenced by the resultant parallel connection.

Because of this, the circuit mentioned initially is normally integrated in the mobile telephone, making it possible to avoid such incorrect measurements, although the circuit is not intended to be active during normal operation of the mobile telephone.

Until now, the necessary circuit for testing functions of the radio-frequency circuit has been implemented as follows: in order to carry out test measurements on the radio-frequency circuit to be tested during production, an additional short-circuiting point was used on a printed circuit board of the mobile telephone, to which the radio-frequency circuit to be tested, the additional circuit component and the circuit for testing functions of the radio-frequency circuit are fitted, with the additional short-circuiting point being short-circuited via an additional test needle on a production line. Thus, according to the prior art, the circuit for testing functions of a radio-frequency circuit requires a separate test needle both for the test point and for the short-circuiting point.

The circuit which has been explained above according to the prior art is illustrated in FIG. 2.

A test point TP is provided, and is designed to engage with a test needle. In detail, the test point TP has two ground contacts, which are arranged opposite one another and are in the form of circle segments, as well as a test point contact, which is arranged between the ground contacts and is connected on one side to a radio-frequency circuit HF′ to be tested, and on its other side to a lambda/4 piece of line L′. A short-circuiting point KP is provided at that end of the lambda/4 piece of line L′ which is remote from the test point TP, and likewise has two ground contacts, which are in the form of circle segments, and a further point contact, which is also connected to ground. An antenna A′, as an additional circuit component which can be disconnected, is short-circuited at the short-circuiting point KP during use of the test needle, since it is connected to one of the ground contacts of the short-circuiting point.

As soon as a test needle is applied to the short-circuiting point KP, and produces a short-circuit there, the short-circuit is transformed via the lambda/4 piece of line to an open circuit at the test point TP. The test point TP, at the same time, makes contact with a test needle which allows a test measurement to be carried out for the radio-frequency circuit without any influence from the antenna A′ that is present.

Furthermore, in the prior art, a procedure is known for allowing test measurements to be carried out without any errors for radio-frequency circuits, in which an additional radio-frequency switch is fitted to the printed circuit board and is used to deactivate the additional circuit component, which can be disconnected, during the production measurements.

Against this background, the present invention is directed toward a circuit for testing functions of a radio-frequency circuit which is simpler than previous circuit arrangements.

### SUMMARY OF THE INVENTION

For the circuit mentioned initially, this is achieved in that the resultant test/short-circuiting point has a signal contact for the signal to be tested and has a ground contact, which are connected via the lambda/4 piece of line, and in that the additional circuit component is connected to the ground contact.

Thus, this circuit arrangement makes it possible not only to carry out test measurements but also to produce the required short-circuit using a single test needle, whose external shape is matched to the relative arrangement of the signal contact and of the ground contact of the circuit. In comparison to the prior art that has already been discussed, this results in the number of test needles that need to be used being halved, and in simplification of the overall circuit. There is no need whatsoever for any additional radio-frequency switch, as is used for other prior art as has been discussed.

The radio-frequency circuit is preferably a Bluetooth, a GSM, a DECT or a “wireless LAN” transmitting/receiving device. Characteristics of radio-frequency circuits such as these can be tested without any problems via a single test needle at the test/short-circuiting point.

When using the circuit in the mobile radio field, the additional circuit component will in many cases be a mobile radio antenna, which can be disconnected in order to test functions of the radio-frequency circuit.

Additional features and advantages of the present invention are described in, and will be apparent from, the following Detailed Description of the Invention and the Figures.

### DESCRIPTION OF THE FIGURES

FIG. 1 shows a circuit for testing functions of a radio-frequency circuit in accordance with the teachings of the present invention.

FIG. 2 shows a circuit for testing functions of a radio-frequency circuit as is known in the prior art.

### DETAILED DESCRIPTION OF THE INVENTION

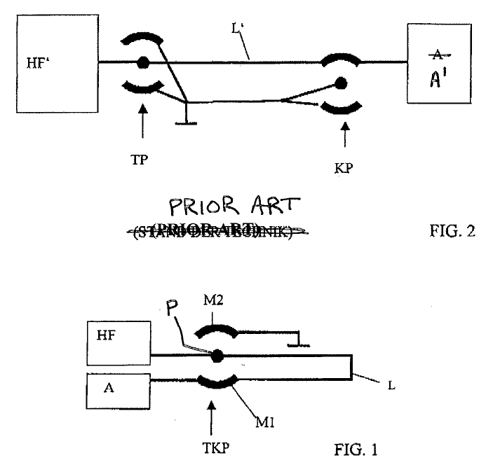

FIG. 1 shows a circuit for testing functions of a radio-frequency circuit HF in accordance with the present invention. The circuit includes a test/short-circuiting point TKP at which signals which are to be tested against characteristics of a radio-frequency circuit that is to be tested are tapped off, as well as at which a necessary short-circuit is provided for an additional circuit component; in the present exemplary embodiment, a mobile radio antenna A.

The test/short-circuiting point TKP has two ground contacts M1, M2 and a test contact P. The two ground contacts M1, M2 are in the form of circle segments and are arranged opposite one another with respect to the center of a circle. The test contact P is provided at the center of the circle.

The test contact P is connected via a lambda/4 piece of line L to the ground contact M1, on whose remaining side the antenna A is arranged.

The necessary short-circuit is transformed via the lambda/4 piece of line L to an open circuit at the test contact P, thus making it possible to carry out a test measurement, without any errors, for the radio-frequency circuit HF, without any influence from the antenna A that is present.

The saving of the separate short-circuiting point KP as provided in the prior art approximately halves the area required for the circuit for testing functions of the radio-frequency circuit HF. The saving of a test needle also leads to reduced costs.

Although the present invention has been described with reference to specific embodiments, those of skill in the art will recognize that changes may be made thereto without departing from the spirit and scope of the invention as set forth in the hereafter appended claims.

1. A circuit for testing functions of a radio-frequency circuit, comprising a single test/short-circuiting point having both a test contact for a test element, at which a signal to be tested is tapped off from the radio-frequency circuit, and a ground contact for a short-circuiting element, via which an additional circuit component, which is connected to the radio-frequency circuit via a lambda/4 piece of line, is short-circuited, wherein the test contact and the ground contact are connected via the lambda/4 piece of line, and the additional circuit component is connected to the ground contact.

2. A circuit for testing functions of a radio-frequency circuit as claimed in claim 1, wherein the radio-frequency circuit is a Bluetooth transmitting/receiving device.

3. A circuit for testing functions of a radio-frequency circuit as claimed in claim 1, wherein the radio-frequency circuit is a GSM transmitting/receiving device.,

4. A circuit for testing functions of a radio-frequency circuit as claimed in claim 1, wherein the radio-frequency circuit is a DECT transmitting/receiving device.

5. A circuit for testing functions of a radio-frequency circuit as claimed in claim 1, wherein the radio-frequency circuit is a wireless LAN transmitting/receiving device.

6. A circuit for testing functions of a radio-frequency circuit as claimed in claim 1, wherein the additional circuit component is a mobile radio antenna.
